(19) United States
(12) Patent Application Publication
(10) Pub. No.: US 2026/0175142 A1
(43) Pub. Date: Jun. 25, 2026

(54) PROTRUDING STRUCTURES

(71) Applicants: Peridot Print LLC, Palo Alto, CA (US); Nanyang Technological University, Singapore (SG)

(72) Inventors: Kim Quy LE, Singapore (SG); Fei DUAN, Singapore (SG); Jia Wei CHEW, Singapore (SG); Jun ZENG, Palo Alto, CA (US); Marcus Yiquan LIN, Singapore (SG)

(21) Appl. No.: 19/124,803

(22) PCT Filed: Oct. 27, 2022
(86) PCT No.: PCT/US2022/048057

§ 371 Date: Apr. 25, 2025

(51) Int. Cl. B01D 19/00

(52) U.S. Cl. CPC B01D 19/0036

(57) ABSTRACT

Examples of screen structures are described herein. In some examples, a screen structure may include an input side. In some examples, the screen structure may include a drainage side to be disposed on an extraction surface. In some examples, the screen structure may include a plurality of channels through the screen structure between the input side and the drainage side. In some examples, the screen structure may include a plurality of protruding structures on the input side, wherein the screen structure is three-dimensionally (3D) printed.

### BACKGROUND

Molded fiber products are products manufactured by molding fiber material, such as wood fiber, pulp, paper, cardboard, cellulose, bamboo, etc. Examples of molded fiber products include packaging, disposable cup holders, egg cartons, food containers, plates, trays, etc. For instance, molded fiber packaging may be utilized to package electronics, appliances, replacement parts, hardware, etc. Some examples of molded fiber products are disposable (e.g., single-use or multiple use disposable), biodegradable, and/or recyclable.

### BRIEF DESCRIPTION OF THE DRAWINGS

FIG. 1 is a diagram illustrating a perspective view of an example of a screen structure;

FIG. 2 is a diagram illustrating a side elevational view of the screen structure described in relation to FIG. 1;

FIG. 3 is a diagram illustrating a perspective view of an example of a screen structure with truncated conical channels;

FIG. 4 is a diagram illustrating a side elevational view of the screen structure described in relation to FIG. 3;

FIG. 5 is a diagram illustrating a perspective view of an example of a screen structure with multi-diameter cylindrical channels;

FIG. 6 is a diagram illustrating a side elevational view of the screen structure described in relation to FIG. 5;

FIG. 7 is a diagram illustrating a perspective view of an example of a screen structure with hybrid cylinder and semi-sphere channels;

FIG. 8 is a diagram illustrating a side elevational view of the screen structure described in relation to FIG. 7;

FIG. 9 is a diagram illustrating a perspective view of an example of a screen structure with oblique cylindrical channels;

FIG. 10 is a diagram illustrating a side elevational view of the screen structure described in relation to FIG. 9;

FIG. 11 is a diagram illustrating a perspective view of an example of a screen structure with oblique cylindrical channels and perpendicular protruding structures;

FIG. 12 is a diagram illustrating a side elevational view of the screen structure described in relation to FIG. 11;

FIG. 13 is a diagram illustrating a perspective view of an example of a screen structure with a concave surface shape;

FIG. 14 is a diagram illustrating a side elevational view of the screen structure described in relation to FIG. 13;

FIG. 15 is a diagram illustrating a perspective view of an example of a screen structure with a convex surface shape;

FIG. 16 is a diagram illustrating a side elevational view of the screen structure described in relation to FIG. 15;

FIG. 17 is a block diagram of an example of an apparatus that may be used to manufacture a structure or structures described herein; and

FIG. 18 is a flow diagram illustrating an example of a method for manufacturing a molded fiber product.

### DETAILED DESCRIPTION

Molded fiber products may provide attractive features, such as low-cost production, reusability, recyclability, and/or sustainability. For instance, some molded fiber products may be utilized as packaging materials to reduce or replace petroleum-based materials.

In some examples, molded fiber products may be manufactured using a slurry. A slurry is a mixture of fluid (e.g., water, liquid, solution, etc.) and fiber material (e.g., wood fiber, pulp, cellulose, bamboo fiber, waste paper, cardboard, etc.). In some approaches, a molded fiber product may be manufactured by molding fiber to a wire mesh on a molding die. For instance, a slurry may be placed on the wire mesh and molding die. The fluid may flow through the molding die to extract the fluid from the slurry (e.g., de-water the slurry) to leave the fiber material molded to the wire mesh and/or molding die.

Drainage time (e.g., fluid extraction time, de-watering time, etc.) is a significant factor in manufacturing speed for molded fiber products. For instance, reducing drainage time may increase manufacturing speed. For low-cost high-volume fiber molded products with various designs, rapid prototyping techniques may also be useful. For example, three-dimensional (3D) printing may be utilized for the design and/or manufacture of screen structures that may reduce drainage time while having the capacity to collect an increased quantity of fibers. In some examples, 3D printing may provide control over screen structure aspects such as channel size, channel angle, channel shape, and/or surface shape, etc. For instance, 3D printing may allow greater control over screen structure features relative to other approaches that utilize wire meshes without controllable features. For instance, 3D printing may allow printing complicated geometrical channel designs such as a cylinder-truncated cone hybrid, a hybrid of cylinders of multiple diameters, a cylinder-semi-sphere hybrid, and/or other channel structure, etc.

Some examples of the techniques described herein include screen structures that can reduce fluid extraction time. For instance, a pattern of protruding structures may be utilized on a screen structure to reduce drainage time (e.g., enhance drainage speed).

In some examples, a screen structure or a part(s) thereof may be manufactured by three-dimensional (3D) printing, another manufacturing technique(s), or a combination thereof. Some examples of 3D printing that may be utilized to manufacture some examples of the structures described herein may include Fused Deposition Modeling (FDM), Multi-Jet Fusion (MJF), Selective Laser Sintering (SLS), binder jet, Stereolithography (SLA), Selective Laser Melting (SLM), Electron Beam Melting (EBM), Metal Jet Fusion, metal binding printing, liquid resin-based printing, etc.

In some examples of 3D printing, thermal energy may be projected over material in a build area, where a phase change and solidification in the material may occur at certain voxels. A voxel is a representation of a location in a 3D space (e.g., a component of a 3D space). For instance, a voxel may represent a volume that is a subset of the 3D space. In some examples, voxels may be arranged on a 3D grid. For instance, a voxel may be cuboid or rectangular prismatic in shape. In some examples, voxels in the 3D space may be uniformly sized or non-uniformly sized. Examples of a voxel size dimension may include 25.4 millimeters (mm)/150≈170 microns for 150 dots per inch (dpi), 490 microns for 50 dpi, 2 mm, 4 mm, etc. In some examples, voxels may be polygonal, polyhedral, irregularly shaped, curved, etc. The term “voxel level” and variations thereof may refer to a resolution, scale, or density corresponding to voxel size.

Some examples of the screen structures described herein may be produced by 3D printing. For instance, some examples may be manufactured with a plastic(s), polymer(s), semi-crystalline material(s), and/or metal(s), etc. Some 3D printing techniques may be powder-based and driven by powder fusion. Some examples of the screen structures described herein may be manufactured with area-based powder bed fusion-based additive manufacturing, such as MJF, Metal Jet Fusion, metal binding printing, SLM, SLS, etc. Some examples of the approaches described herein may be applied to additive manufacturing where agents carried by droplets are utilized for voxel-level thermal modulation.

In some examples of additive manufacturing, thermal energy may be utilized to fuse material (e.g., particles, powder, etc.) to form an object (e.g., structure, geometry, etc.). For example, agents (e.g., fusing agent, detailing agent, etc.) may be selectively deposited to control voxel-level energy deposition, which may trigger a phase change and/or solidification for selected voxels.

In some examples of 3D printing, a binding agent (e.g., adhesive) may be printed onto material in a build volume to bind powder (e.g., particles) and form a precursor object (e.g., “green part”). The precursor object may be heated (in an oven or heating apparatus, for example) to sinter the precursor object and form a solid part.

Throughout the drawings, similar reference numbers may designate similar or identical elements. When an element is referred to without a reference number, this may refer to the element generally, without limitation to any particular drawing or figure. In some examples, the drawings are not to scale and/or the size of some parts may be exaggerated to more clearly illustrate the example shown. Moreover, the drawings provide examples in accordance with the description. However, the description is not limited to the examples provided in the drawings.

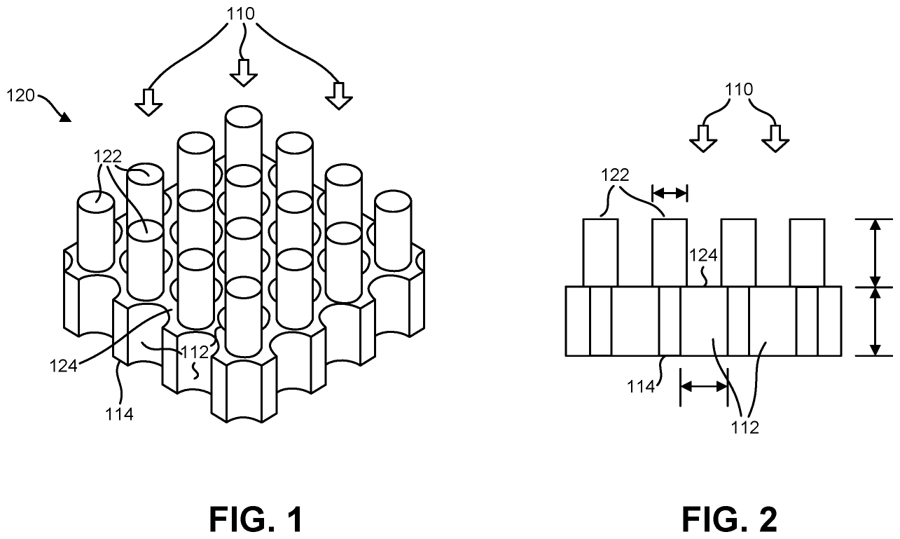

FIG. 1 is a diagram illustrating a perspective view of an example of a screen structure 120. FIG. 2 is a diagram illustrating a side elevational view of the screen structure 120 described in relation to FIG. 1. FIG. 1 and FIG. 2 are described together. A screen structure is a structure to separate substances (e.g., to separate fluid from matter suspended in the fluid). For instance, the screen structure 120 may be utilized to separate fluid from fiber material. In some examples, a screen structure thickness may be between 0.5 millimeters (mm) and 3 mm. In the examples of FIGS. 1-2, the screen structure 120 has a thickness of 2 mm, including 1 mm for base or channel height and 1 mm for protrusion height.

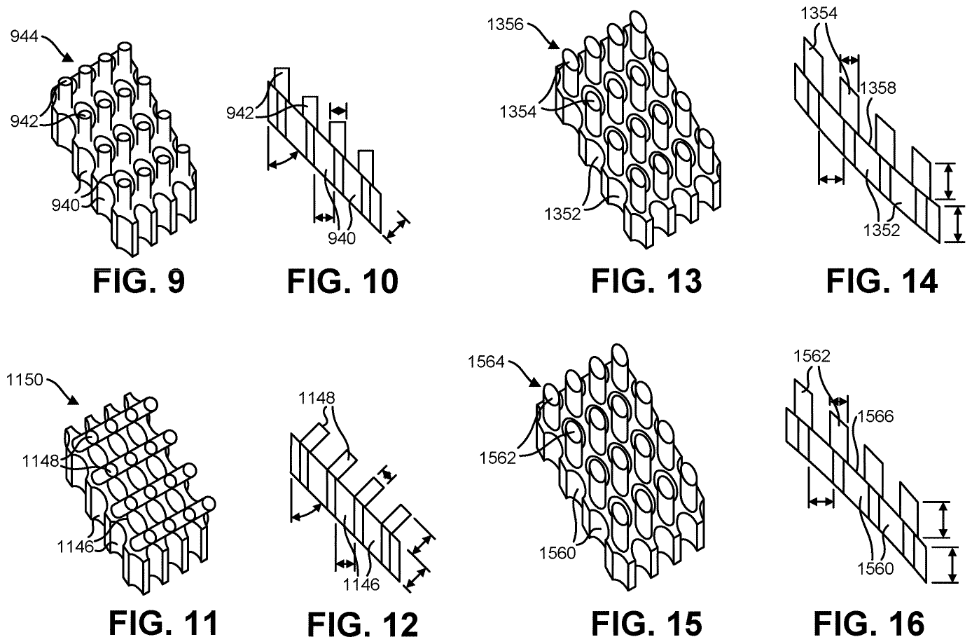

The screen structure 120 may include an input side 124. An input side is a side of a screen structure where a substance (e.g., slurry) is to be disposed for processing (e.g., filtering, molding, etc.). For instance, a slurry of fluid and fiber material may be placed on the input side 124 to separate the fluid from the fiber material and/or to mold the fiber material on the input side 124. The input side 124 may receive the slurry. In some examples, fiber material may conform to the input side 124 to produce a molded fiber product. In some examples, an input side may have a surface shape (e.g., curved, concave, convex, etc.). Examples of various surface shapes of input sides are described in relation to FIGS. 9-16.

The screen structure 120 may include a drainage side 114. A drainage side is a side of a screen structure where a separated substance (e.g., fluid, liquid, etc.) is to emerge and/or drain. For instance, the screen structure 120 may partially or completely separate components of a slurry (e.g., may separate fluid from fiber material). The fiber material may remain on the input side 124, while fluid may flow through the screen structure 120 and drain from the drainage side 114. The drainage side 114 may expel fluid.

In some examples, the drainage side 114 may be disposed on an extraction surface (not shown in FIG. 1). For instance, the drainage side 114 may be placed on (and/or may be attached to) an extraction surface. An extraction surface is a porous surface to extract (e.g., drain, suction, etc.) a substance (e.g., fluid, liquid, water, etc.). In some examples, the extraction surface may have pores that are larger than openings defined by channels (e.g., channels 112) in the screen structure 120. In some examples, the extraction surface may be coupled to a suction device (e.g., vacuum pump). The extraction surface may extract the substance (e.g., fluid, liquid, water, etc.) from the drainage side 114 of the screen structure 120.

In some examples, a drainage side may be smooth and/or flat. For instance, the drainage side 114 illustrated in FIGS. 1-2 is flat. In some examples, a drainage side may include a protuberance(s) (not shown in FIG. 1). For instance, a drainage side may include a protuberance(s) that separate the holes in the drainage side 114 from the extraction surface. In some examples, the extraction surface is a surface of a molding die and/or forming tool. The molding die and/or forming tool may be connected to a suction device. In some examples, the screen structure 120 may sit on top of the extraction surface (e.g., molding die and/or forming tool). Liquid from slurry may pass through the screen structure 120 and the extraction surface. In some examples, the extraction surface (e.g., molding die and/or forming tool) may have a similar shape as the screen structure 120.

The screen structure 120 may include channels 112 (e.g., a plurality of channels). A channel is a structure (e.g., course, route, path, etc.) to conduct a substance (e.g., fluid, liquid, water, etc.). For instance, a channel may provide a conduit to pass fluid. A channel may include a surface(s). For instance, the channels 112 may include surfaces in the interior of the screen structure 120. In some examples, the channels 112 may be circular (e.g., tubular, cylindrical), conical, elliptical, rectangular, irregularly shaped, curved, prismatic, polygonal, or a combination thereof. In some examples, channels may be approximately uniform in shape. For instance, the channels 112 illustrated in FIG. 1 are uniformly shaped cylinders (with some cylinders truncated along the edges of the screen structure 120). In some examples, the channels 112 are disposed through the screen structure 120 between the input side 124 and the drainage side 114. The channels 112 may be utilized to conduct the substance (e.g., fluid) from the input side 124 to the drainage side 114.

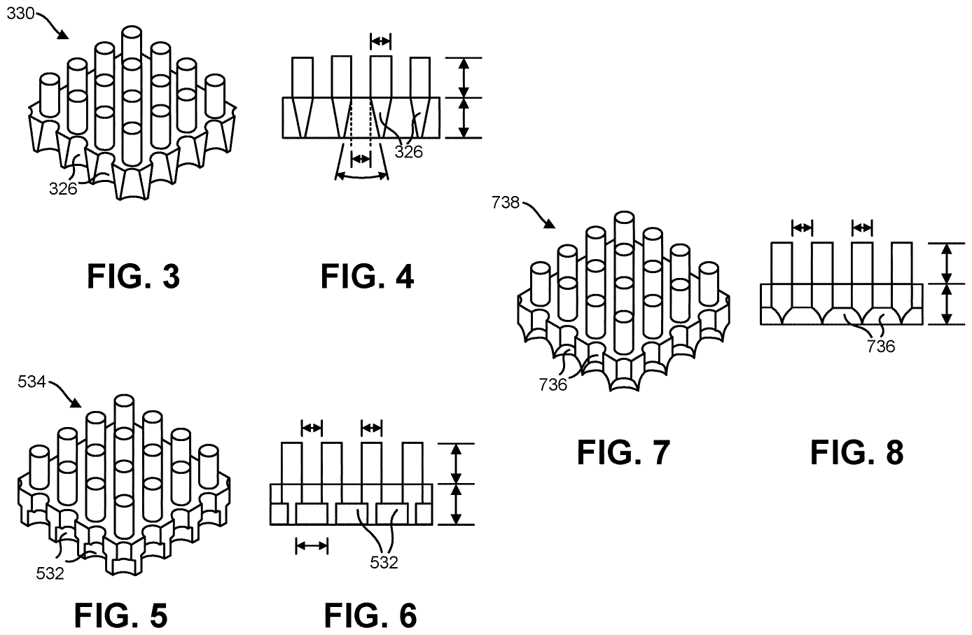

In some examples, a channel may be shaped as a cylindrical pillar, polyhedron, dome, cone, spike, combinations thereof, and/or truncated versions thereof. In the example of FIGS. 1-2, the channels 112 are shaped as cylindrical channels. In some examples, a cylindrical channel may have a diameter between 0.1 millimeters (mm) and 2 mm. In the example of FIGS. 1-2, the channels 112 are cylindrical channels with diameters of 0.7 mm. In the example of FIGS. 1-2, the channels 112 have a quantity of 1.07 channels/mm². In some examples, channel size (e.g., diameter) may vary relative to screen structure depth. For instance, a channel may have a first size (e.g., first diameter) at an input side and a second size (e.g., second diameter) at a drainage side. In some examples, the first size may be smaller than the second size, approximately the same as the second size, or larger than the second size. In the example of FIGS. 1-2, the space in the channels 112 has a volume ratio of 20.97 to a volume of the screen structure 120. Examples of channels with different shapes are described in relation to FIGS. 3-8.

The screen structure 120 may include protruding structures 122 (e.g., a plurality of protruding structures) on the input side 124. A protruding structure is a structure that extends from a surface and/or extends the surface outwardly. For instance, the protruding structures 122 protrude outwardly on the input side 124. In the example of FIGS. 1-2, the protruding structures 122 protrude in a perpendicular direction from the input side 124. Examples of protruding directions are described in relation to FIGS. 9-12. In some examples, the protruding structures 122 may protrude from the input side 124 in a direction opposing a fluid flow direction 110 through the screen structure 120. For instance, protrusions may extend in a direction(s) at a protrusion angle away from the fluid flow direction 110 (e.g., 90°<protrusion angle<270°, at an obtuse angle or reflex angle) relative to a fluid flow direction. In FIG. 1, the protruding structures 122 extend in a direction approximately opposite from (e.g., 180° relative to) the fluid flow direction 110.

In some examples, a protruding structure(s) may be situated between channels. For instance, the protruding structures 122 are each situated between channels 112. In some examples, each protruding structure may be disposed between channels along two axes (e.g., orthogonal axes).

In some examples, the protruding structures 122 may protrude into a slurry volume. For instance, the protruding structures 122 may protrude into a volume of a container (not shown in FIG. 1) to hold a slurry. In some examples, fluid of a slurry may flow from the input side 124 of the screen structure 120 with the protruding structures 122, into the channels 112, and out of the drainage side 114.

In some examples, a protruding structure may be shaped as a cylindrical pillar, polyhedron, dome, cone, spike, combinations thereof, and/or truncated versions thereof. In the example of FIGS. 1-2, the protruding structures 122 are a plurality of pillars (e.g., cylindrical pillars, polyhedral pillars, domed pillars, conical pillars, rectangular pillars, etc.). In some examples, a pillar may have a dimension (e.g., hydraulic diameter, width dimension, cross-sectional dimension, etc.) between 0.1 mm and 2 mm (e.g., between 0.25 mm and 0.75 mm). A hydraulic diameter is a value based on a dimension(s) of a body (e.g., rod, pillar, duct, tube, etc.) that provides a similar (e.g., equivalent) flow property to a circular (e.g., cylindrical) body having a diameter equal to the hydraulic diameter. For instance, a circular or non-circular pillar with a hydraulic diameter may exhibit a similar flow property to a circular (e.g., cylindrical) pillar with a diameter of the same size as the hydraulic diameter. In the example of FIGS. 1-2, the protruding structures 122 are cylindrical pillars with diameters of 0.5 mm. In some examples, a cylindrical pillar may have a height (e.g., height from a channel top level) between 0.1 mm and 2 mm (e.g., between 0.2 mm and 1 mm). In the example of FIGS. 1-2, the protruding structures 122 are cylindrical pillars with heights of 1 mm. In some examples, a pillar height of about 1 mm may increase drainage speed by approximately 31% compared to a screen without protruding structures. A pillar height of 0.2 mm may increase drainage speed by about 7% and pillar heights of 0.3 mm or more may increase drainage speed by about 23.5% or more.

In some examples, protruding structures may occupy a proportion of a surface area of an input side. For instance, protruding structures may occupy a proportion between 4.5% and 91.6% (e.g., between 10% and 90%) of a surface area of an input side. For instance, pillars may cover between 10% and 90% of surface area (e.g., surface area excluding channel opening area). In some examples, a surface area coverage of about 55.4% (e.g., cylinder diameter of 0.7 mm) may increase drainage speed by approximately 25% compared to a screen without protruding structures. In the example of FIGS. 1-2, the protruding structures 122 have a quantity of 1.14 pillars/mm².

In some examples, the screen structure 120 may be three-dimensionally (3D) printed. For instance, a 3D printer may utilize printing instructions and/or data (e.g., 3D model data, an agent map(s), slice(s), etc.) that spatially indicate a printing region(s) to form the screen structure 120. In some examples, the printing instructions and/or data may indicate a dimension(s) for the input side 124, drainage side 114, channel 112, and/or protruding structures 122. In some examples, a device (e.g., computing device) and/or 3D printer may add protruding structures to an input side of a screen structure model.

The protruding structures 122 may increase a surface area of the input side 124 relative to a screen without protrusions. The increased surface area may increase drainage speed by changing a contact angle between the slurry and the input side 124. In some examples, the protruding structures 122 may help to reduce and/or avoid channel clogging. In some examples, the protruding structures 122 may help to break surface tension of the slurry to increase draining speed.

FIG. 3 is a diagram illustrating a perspective view of an example of a screen structure 330 with truncated conical channels 326. FIG. 4 is a diagram illustrating a side elevational view of the screen structure 330 described in relation to FIG. 3. FIG. 3 and FIG. 4 are described together. The screen structure 330 includes some aspects similar to those described in relation to FIGS. 1-2 (e.g., similar pillar dimensions and screen structure thickness).

In the example of FIGS. 3-4, the truncated conical channels 326 have a diameter of 0.5 mm at the input side of the screen structure 330 and angle inwardly by 21.8° relative to an axial direction (e.g., flow direction) of the truncated conical channels 326. In the example of FIGS. 3-4, the truncated conical channels 326 are spaced by 0.5 mm. In some examples, the truncated conical channels 326 may reduce the fibers in the permeated slurry as compared to cylindrical channels with the same volumetric density.

FIG. 5 is a diagram illustrating a perspective view of an example of a screen structure 534 with multi-diameter cylindrical channels 532. FIG. 6 is a diagram illustrating a side elevational view of the screen structure 534 described in relation to FIG. 5. FIG. 5 and FIG. 6 are described together. The screen structure 534 includes some aspects similar to those described in relation to FIGS. 1-2 (e.g., similar pillar dimensions and screen structure thickness).

In the example of FIGS. 5-6, the multi-diameter cylindrical channels 532 have a diameter of 0.5 mm at the input side of the screen structure 534 and a diameter of 0.79 mm at the drainage side of the screen structure 534. In the example of FIGS. 5-6, the multi-diameter cylindrical channels 532 are spaced on the input side by 0.5 mm. In some examples, the multi-diameter cylindrical channels 532 may transition from a first diameter of 0.5 mm to a second diameter of 0.79 mm between (e.g., midway between) the input side and the drainage side.

FIG. 7 is a diagram illustrating a perspective view of an example of a screen structure 738 with hybrid cylinder and semi-sphere channels 736. FIG. 8 is a diagram illustrating a side elevational view of the screen structure 738 described in relation to FIG. 7. FIG. 7 and FIG. 8 are described together. The screen structure 738 includes some aspects similar to those described in relation to FIGS. 1-2 (e.g., similar pillar dimensions and screen structure thickness).

In the example of FIGS. 7-8, the hybrid cylinder and semi-sphere channels 736 have a diameter of 0.5 mm at the input side of the screen structure 738 and a diameter of 0.96 mm at the drainage side of the screen structure 738. In the example of FIGS. 7-8, the hybrid cylinder and semi-sphere channels 736 are spaced on the input side by 0.5 mm. In some examples, the hybrid cylinder and semi-sphere channels 736 may transition from a first diameter of 0.5 mm to a semi-sphere radius of 0.48 mm between the input side and the drainage side. The channel geometries described in relation to FIGS. 3-8 may enhance drainage speed by 7%-9% relative to straight cylindrical channels.

FIG. 9 is a diagram illustrating a perspective view of an example of a screen structure 944 with oblique cylindrical channels 940. FIG. 10 is a diagram illustrating a side elevational view of the screen structure 944 described in relation to FIG. 9. FIG. 9 and FIG. 10 are described together. The screen structure 944 includes some aspects similar to those described in relation to FIGS. 1-2 (e.g., similar pillar diameter and screen structure thickness).

In the example of FIGS. 9-10, the oblique cylindrical channels 940 have a diameter of 0.7 mm. The oblique cylindrical channels 940 are disposed at an oblique angle (e.g., 45°) relative to the input side and drainage side. In the example of FIGS. 9-10, the screen structure 944 also includes protruding structures 942 on the input side disposed at an oblique angle (e.g., 45°) relative to the input side. In some examples, the screen structure 944 may be sloped (e.g., sloped relative to a horizontal orientation). In some examples, the extremities (e.g., tops) of the protruding structures 942 may be angled differently (e.g., obliquely) relative to a base surface.

FIG. 11 is a diagram illustrating a perspective view of an example of a screen structure 1150 with oblique cylindrical channels 1146 and perpendicular protruding structures 1148. FIG. 12 is a diagram illustrating a side elevational view of the screen structure 1150 described in relation to FIG. 11. FIG. 11 and FIG. 12 are described together. The screen structure 1150 includes some aspects similar to those described in relation to FIGS. 1-2 (e.g., similar pillar dimensions and screen structure thickness).

In the example of FIGS. 11-12, the oblique cylindrical channels 1146 have a diameter of 0.7 mm. The oblique cylindrical channels 1146 are disposed at an oblique angle (e.g., 45°) relative to the input side and drainage side. In the example of FIGS. 11-12, the screen structure 1150 also includes protruding structures 1148 on the input side disposed at a perpendicular angle (e.g., 90°) relative to the input side. In some examples, the screen structure 1150 may be sloped (e.g., sloped relative to a horizontal orientation). In some examples, the extremities (e.g., tops) of the protruding structures 1148 may be parallel to a base surface.

FIG. 13 is a diagram illustrating a perspective view of an example of a screen structure 1356 with a concave surface shape 1358. FIG. 14 is a diagram illustrating a side elevational view of the screen structure 1356 described in relation to FIG. 13. FIG. 13 and FIG. 14 are described together. The screen structure 1356 includes some aspects similar to those described in relation to FIGS. 1-2 (e.g., similar pillar dimensions and screen structure thickness).

In the example of FIGS. 13-14, the cylindrical channels 1352 have a diameter of 0.7 mm. The cylindrical channels 1352 are disposed in a vertical orientation relative to the concave surface shape 1358. In the example of FIGS. 13-14, the screen structure 1356 also includes protruding structures 1354 on the input side disposed in a vertical orientation relative to the concave surface shape 1358. In some examples, concave surface shape 1358 may have a curvature on the base surface relative to a radius of 32.5 mm with an origin above the concave surface shape 1358. In some examples, the extremities (e.g., tops) of the protruding structures 1354 may follow the concave curvature.

FIG. 15 is a diagram illustrating a perspective view of an example of a screen structure 1564 with a convex surface shape 1566. FIG. 16 is a diagram illustrating a side elevational view of the screen structure 1564 described in relation to FIG. 15. FIG. 15 and FIG. 16 are described together. The screen structure 1564 includes some aspects similar to those described in relation to FIGS. 1-2 (e.g., similar pillar dimensions and screen structure thickness).

In the example of FIGS. 15-16, the cylindrical channels 1560 have a diameter of 0.7 mm. The cylindrical channels 1560 are disposed in a vertical orientation relative to the convex surface shape 1566. In the example of FIGS. 15-16, the screen structure 1564 also includes protruding structures 1562 on the input side disposed in a vertical orientation relative to the convex surface shape 1566. In some examples, convex surface shape 1566 may have a curvature on the base surface relative to a radius of 32.5 mm with an origin below the convex surface shape 1566. In some examples, the extremities (e.g., tops) of the protruding structures 1354 may follow the convex curvature.

In some examples, the protruding structure geometries described in relation to FIGS. 9-16 may enhance drainage speed by 30%-40% relative to screen structures without protruding structures. Of the examples described in relation to FIGS. 9-16, the concave surface shape performed with a fastest draining speed (e.g., approximately 1.6 seconds(s) versus 3.1 s of the design of FIG. 9, 3.1 s of the design of FIG. 11, and 2.8 s of the design of FIG. 13).

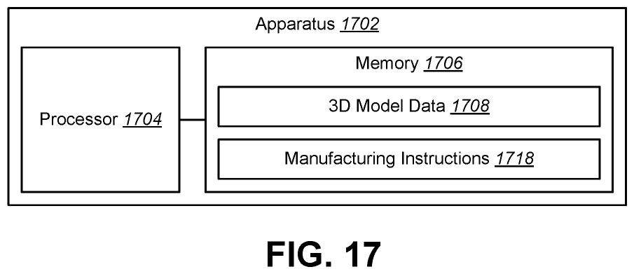

FIG. 17 is a block diagram of an example of an apparatus 1702 that may be used to manufacture a structure or structures described herein. The apparatus 1702 may be a computing device, such as a personal computer, a server computer, a printer, a 3D printer, a smartphone, a tablet computer, etc. The apparatus 1702 may include and/or may be coupled to a processor 1704 and/or to a memory 1706. The processor 1704 may be in electronic communication with the memory 1706. In some examples, the apparatus 1702 may be in communication with (e.g., coupled to, have a communication link with) a manufacturing device (e.g., a 3D printing device). In some examples, the apparatus 1702 may be an example of a 3D printing device. The apparatus 1702 may include additional components (not shown) and/or some of the components described herein may be removed and/or modified without departing from the scope of this disclosure.

The processor 1704 may be any of a central processing unit (CPU), a semiconductor-based microprocessor, graphics processing unit (GPU), field-programmable gate array (FPGA), an application-specific integrated circuit (ASIC), and/or other hardware device suitable for retrieval and execution of instructions stored in the memory 1706. The processor 1704 may fetch, decode, and/or execute instructions (e.g., manufacturing instructions 1718) stored in the memory 1706. In some examples, the processor 1704 may include an electronic circuit or circuits that include electronic components for performing a functionality or functionalities of the instructions (e.g., manufacturing instructions 1718). In some examples, the processor 1704 may be utilized to manufacture one, some, or all of the structures described in relation to one, some, or all of FIGS. 1-16 and/or 18.

The memory 1706 may be any electronic, magnetic, optical, or other physical storage device that contains or stores electronic information (e.g., instructions and/or data). Thus, the memory 1706 may be, for example, Random Access Memory (RAM), Electrically Erasable Programmable Read-Only Memory (EEPROM), a storage device, an optical disc, and the like. In some implementations, the memory 1706 may be a non-transitory tangible machine-readable storage medium, where the term “non-transitory” does not encompass transitory propagating signals.

In some examples, the apparatus 1702 may also include a data store (not shown) on which the processor 1704 may store information. The data store may be volatile and/or non-volatile memory, such as Dynamic Random-Access Memory (DRAM), EEPROM, magnetoresistive random-access memory (MRAM), phase change RAM (PCRAM), memristor, flash memory, and the like. In some examples, the memory 1706 may be included in the data store. In some examples, the memory 1706 may be separate from the data store. In some approaches, the data store may store similar instructions and/or data as that stored by the memory 1706. For example, the data store may be non-volatile memory and the memory 1706 may be volatile memory.

In some examples, the apparatus 1702 may include a communication interface (not shown) through which the processor 1704 may communicate with an external device or devices (not shown), for instance, to receive and/or store information pertaining to an object or objects (e.g., geometry(ies), screen structure(s), etc.) to be manufactured. The communication interface may include hardware and/or machine-readable instructions to enable the processor 1704 to communicate with the external device or devices. The communication interface may enable a wired and/or wireless connection to the external device or devices. In some examples, the communication interface may further include a network interface card and/or may also include hardware and/or machine-readable instructions to enable the processor 1704 to communicate with various input and/or output devices. Examples of input devices may include a keyboard, a mouse, a display, another apparatus, electronic device, computing device, etc., through which a user may input instructions into the apparatus 1702. In some examples, the apparatus 1702 may receive 3D model data 1708 from an external device or devices (e.g., 3D scanner, removable storage, network device, etc.).

In some examples, the memory 1706 may store 3D model data 1708. The 3D model data 1708 may be generated by the apparatus 1702 and/or received from another device. Some examples of 3D model data 1708 include a CAD file(s), a 3D manufacturing format (3MF) file(s), object shape data, mesh data, geometry data, etc. The 3D model data 1708 may indicate the shape of an object or objects. For instance, the 3D model data 1708 may indicate the shape of a geometry(ies) (e.g., regular and/or irregular geometries), a screen structure(s), a channel(s), and/or a protruding structure(s), etc., described herein, for manufacture.

In some examples, the processor 1704 may execute the manufacturing instructions 1718 to control a print mechanism (e.g., printhead, laser, nozzle, etc.) to print a screen structure. The screen structure may include an input side having a plurality of protruding structures and a plurality of channels from the input side to a drainage side. In some examples, the processor 1704 may control the print mechanism to print the plurality of protruding structures as a plurality of cylinders. In some examples, the plurality of protruding structures may protrude at an oblique angle from the input side.

In some examples, the processor 1704 may control a print mechanism and/or may send instructions to a 3D printer to print the screen structure. For instance, the processor 1704 (e.g., microprocessor) may control printing of the screen structure in accordance with a 3D printing technique or techniques (e.g., SLM, EBM, FDM, and/or binder jet, etc.).

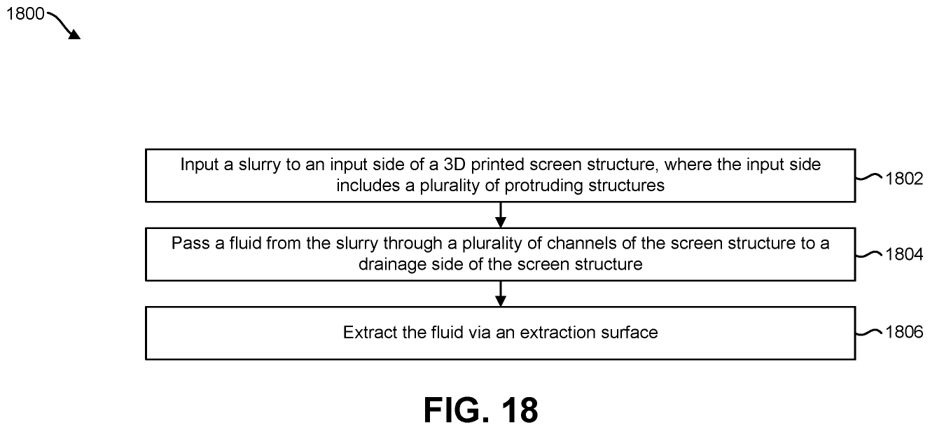

FIG. 18 is a flow diagram illustrating an example of a method 1800 for manufacturing a molded fiber product. The method 1800 and/or an element or elements of the method 1800 may be performed using a screen structure described herein (e.g., a screen structure described in relation to one, some, or all of FIGS. 1-17). For example, the method 1800 may be performed by a manufacturing device that includes a screen structure described herein.

The manufacturing device may input 1802 a slurry to an input side of a 3D printed screen structure. The input side may include a plurality of protruding structures. For instance, the plurality of protruding structures may protrude in a perpendicular direction from the input side of the screen structure. In some examples, the manufacturing device may include a slurry container with the screen structure disposed in the slurry container (e.g., at a bottom of the slurry container). The slurry container may input the slurry to the input side of the 3D printed screen structure.

The manufacturing device may pass 1804 a fluid from the slurry through a plurality of channels of the screen structure to a drainage side of the screen structure. For instance, the fluid may pass through the channels via gravitational force, a suction force, or a combination thereof.

The manufacturing device may extract 1806 the fluid via an extract surface. For instance, a porous extraction surface may be disposed below the screen structure. The extraction surface may extract the fluid from the drainage side of the screen structure. In some examples, the fluid is extracted using suction produced by a vacuum (e.g., a vacuum pump).

In some examples, passing 1804 the fluid and/or extracting 1806 the fluid may result in a layer of fiber material (e.g., molded fiber material) on the screen. In some examples, the layer of fiber material may be dried (e.g., air dried, heated, and/or compressed). For instance, the manufacturing device may dry the fiber material by heating the fiber material, blowing air on the fiber material, pressing the fiber material, or a combination thereof. The dried fiber material may be a molded fiber product. In some examples, the fiber material (e.g., molded fiber product) may be removed from the screen structure. For instance, the manufacturing device may separate the fiber material (e.g., molded fiber product) from the screen structure. In some examples, the molded fiber product may not include a wire mesh. In some examples, the molded fiber product may include indentations in a surface of the molded fiber product from the protruding structures.

As used herein, the term “and/or” may mean an item or items. For example, the phrase “A, B, and/or C” may mean any of: A (without B and C), B (without A and C), C (without A and B), A and B (but not C), B and C (but not A), A and C (but not B), or all of A, B, and C.

While various examples of systems and methods are described herein, the systems and methods are not limited to the examples. Variations of the examples described herein may be implemented within the scope of the disclosure. For example, operations, functions, aspects, or elements of the examples described herein may be omitted or combined.

1. A screen structure, comprising:
an input side;
a drainage side to be disposed on an extraction surface;
a plurality of channels through the screen structure between the input side and the drainage side; and
a plurality of protruding structures on the input side, wherein the screen structure is three-dimensionally (3D) printed.

2. The screen structure of claim 1, wherein the plurality of protruding structures is to protrude from the input side in a direction opposing a fluid flow direction through the screen structure.

3. The screen structure of claim 1, wherein the extraction surface is a surface of a molding die.

4. The screen structure of claim 1, wherein the plurality of protruding structures comprises a plurality of pillars.

5. The screen structure of claim 4, wherein each pillar of the plurality of pillars has a hydraulic diameter between 0.25 millimeters (mm) and 2 mm.

6. The screen structure of claim 1, wherein the plurality of protruding structures occupies a proportion between 10% and 90% of a surface area of the input side.

7. The screen structure of claim 1, wherein a protruding structure is situated between channels.

8. The screen structure of claim 1, wherein a channel of the plurality of channels has a first size at the input side that is smaller than a second size at the drainage side.

9. The screen structure of claim 1, wherein the input side comprises a curved surface.

10. A method, comprising:
inputting a slurry to an input side of a three-dimensionally (3D) printed screen structure, wherein the input side comprises a plurality of protruding structures;
passing a fluid from the slurry through a plurality of channels of the screen structure to a drainage side of the screen structure; and
extracting the fluid via an extraction surface.

11. The method of claim 10, wherein the fluid is extracted using suction produced by a vacuum.

12. The method of claim 10, wherein the plurality of protruding structures protrudes in a perpendicular direction from the input side of the screen structure.

13. An apparatus, comprising:
a memory; and
a processor in electronic communication with the memory, wherein the processor is to:
control a print mechanism to print a screen structure, wherein the screen structure comprises an input side having a plurality of protruding structures and a plurality of channels from the input side to a drainage side.

14. The apparatus of claim 13, wherein the processor is to control the print mechanism to print the plurality of protruding structures as a plurality of cylinders.

15. The apparatus of claim 13, wherein the plurality of protruding structures protrudes at an oblique angle from the input side.
